(19) United States
(12) Patent Application Publication
(10) Pub. No.: US 2023/0396052 A1
(43) Pub. Date: Dec. 7, 2023

(54) ARC SUPPRESSION PRE-CHARGE CIRCUIT

(71) Applicant: YAZAKI NORTH AMERICA, INC., Canton, MI (US)

(72) Inventors: Yuanyuan Wu, Manchester, MI (US); Kenneth Russel, South Lyon, MI (US)

(73) Assignee: YAZAKI NORTH AMERICA, INC., Canton, MI (US)

(21) Appl. No.: 18/034,263

(22) PCT Filed: Nov. 1, 2021
(86) PCT No.: PCT/US2021/057540

§ 371 Date: Apr. 27, 2023

Related U.S. Application Data
(60) Provisional application No. 63/107,711, filed on Oct. 30, 2020.

(51) Int. Cl. H02H 1/04; H02H 11/00

(52) U.S. Cl. CPC H02H 1/043; H02H 11/007; H02H 9/025

(57) ABSTRACT

An arc suppression pre-charge circuit includes a source for providing energy to a load and a main contactor selectively closed to provide energy from the source to the load, wherein the main contactor provides an alternate current path from the source to the load and bypasses a pre-charge branch of the circuit when the main contactor is closed. The pre-charge branch includes a voltage-controlled resistor and a control circuit configured to control a resistance of the voltage-controlled resistor.

### CROSS-REFERENCE TO RELATED APPLICATIONS

This application claims the benefit of and priority to U.S. Provisional Patent Application No. 63/107,711, filed Oct. 30, 2020, the contents of which are incorporated herein by reference in its entirety

### BACKGROUND

The present disclosure relates generally to pre-charge circuits. More specifically, the present disclosure relates to arc suppression pre-charge circuits. The connection of an uncharged capacitive load to a power source (e.g., a battery, a power supply, a grid, etc.) may result in sudden, large surge currents (i.e., transient currents, switch-on surge, inrush currents, etc.) through an electrical system. This is due, in part, to the nature of uncharged or partially charged capacitive elements, which typically appear to a source as a short circuit in the electrical system when the potential (i.e., voltage) of the power source is higher than the potential of the capacitive load.

The rapid draw of current from the power source following an initial powering on of an electrical system coupling the source and load may potentially damage components of the electrical system or shorten the operating lifetime of the electrical system and/or its components by placing considerable stress on the system. For example, surge currents may cause arcing as a mechanical switch (e.g., a contactor) of the electrical system is transitioned from closed to open and/or open to closed. The arcing of a switch may be particularly problematic as it may lead to welded contacts in the switch. Welded contacts are a short in the switch, and thus prevent the flow of current between the source and load from being broken. In this regard, welded contacts may prevent the circuit from being safely de-energized. As such, in addition to negatively impacting the functioning of the electrical system, surge or inrush currents may also be potentially dangerous to a user of the electrical system.

### SUMMARY

At least one embodiment relates to an arc suppression pre-charge circuit. The arc suppression pre-charge circuit includes a source for providing energy to a load and a main contactor selectively closed to provide energy from the source to the load, wherein the main contactor provides an alternate current path from the source to the load and bypasses a pre-charge branch of the circuit when the main contactor is closed. The pre-charge branch includes a voltage-controlled resistor and a control circuit configured to control a resistance of the voltage-controlled resistor.

Another embodiment relates to an arc suppression pre-charge device, The arc suppression pre-charge device includes a housing and an arc suppression pre-charge circuit at least partially disposed in the housing, The arc suppression pre-charge circuit includes a source for providing energy to a load and a main contactor selectively closed to provide energy from the source to the load, wherein the main contactor provides an alternate current path from the source to the load and bypasses a pre-charge branch of the circuit when the main contactor is closed. The pre-charge branch includes a voltage-controlled resistor and a control circuit configured to control a resistance of the voltage-controlled resistor.

Yet another embodiment relates to a method of using an arc suppression pre-charge circuit. The method includes initiating operations of the arc suppression pre-charge circuit, and in response to determining that pre-charge conditions of a load are not met, applying a voltage to a gate of a voltage-controlled resistor via the arc suppression pre-charge circuit. The voltage applied to the gate causes current to flow through a pre-charge branch of the pre-charge circuit along a bypass path to the load, instead of through a main contactor to the load.

This summary is illustrative only should not be regarded as limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a diagram of a circuit in a pre-charge configuration, according to one example embodiment.

FIG. 2 is a diagram of the circuit of FIG. 1 in a charging configuration, according to one example embodiment.

FIG. 3 is a diagram of a circuit in a pre-charge configuration, according to one example embodiment.

FIG. 4 is a diagram of the circuit of FIG. 3 in a charging configuration, according to one example embodiment.

FIG. 5 is a diagram of a circuit, according to one embodiment.

FIG. 6 is a graph representative of the operation of a field effect transistor (FET) in a linear mode, according to one example embodiment.

FIGS. 7A-7B are flow diagrams of a process for pre-charging a load, according to one embodiment.

FIG. 8 is a diagram of a drive system for a motor that includes the circuit of FIG. 5, according to one embodiment.

FIG. 9A is a diagram of a mini four-pin relay with a pre-charge circuit, according to one embodiment.

FIG. 9B is a diagram of a mini five-pin relay with a pre-charge circuit, according to one embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, limiting the flow of current to a capacitive load during an initial stage in the charging of the load may help to mitigate the stresses and damages to an electrical system, and dangers to a user associated with inrush currents. By limiting initial current flow to the load, capacitive elements of the load may charge in a controlled manner, thus avoiding large surges in current within the electrical system. Thus, providing an initial duration of limited current flow during the charging of an electrical system comprising a capacitive load may increase the operating lifetime of the electrical system and its components, and increase the safety and reliability of the electrical system.

Non-limiting examples of electrical systems that include capacitive loads for which such an initial, limited current flow charging phase would be advantageous include fully powered electric vehicles (EVs), or partially powered hybrid electric vehicles (HEVs), that include an inverter for converting DC power, such as from a battery, to AC power for running electric motors, starter-generators, etc. Inverters, such as those utilized in EVs, HEVs, etc., generally contain one or more capacitive elements, such as filtering capacitors that act to reduce electrical noise, harmonic distortion, and ripple voltage. Referring generally to the figures, circuits having features that a) limit inrush current during pre-charge mode and b) minimizing arcing are shown.

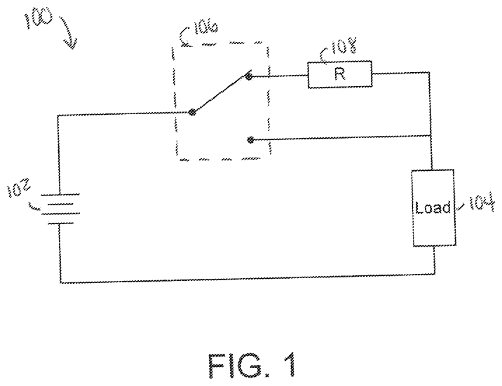

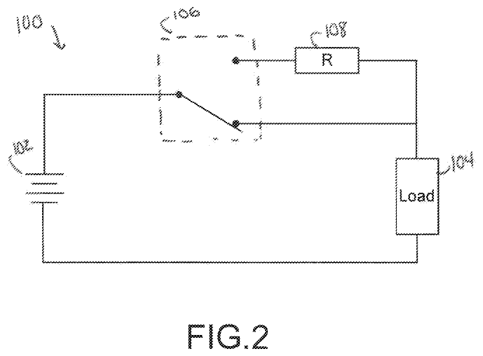

Referring to FIGS. 1 and 2, a diagram of a circuit 100 that limits current flow during an initial charging of a load, and which mitigates dangers posed by arcing, is shown according to one embodiment. The circuit 100 includes a power source 102 that is configured to selectively provide energy to a load 104. The power source 102 may comprise any AC or DC source (e.g., a battery, a generator, a grid, etc.). The load 104 may comprise any load having a capacitance and/or one or more capacitive elements (e.g., capacitors). For example, load 104 may be a converter, configured to convert alternating current (AC) to direct current (DC), or an inverter, configured to convert DC to AC. As another example, the load 104 may comprise filtering capacitors that act to reduce electrical noise, harmonic distortion, and ripple voltage.

The circuit 100 also includes a pre-charge branch and a charging branch that are arranged in parallel between the power source and load. Each of the pre-charge branch and charging branch include a switch via which a current flow path may selectively be established between the power source and load. The switch 106 is any mechanical, multi-pole switch capable of selectively transitioning between an open configuration (in which current flow across the switch is prevented) and a closed configuration (in which current may flow across the switch).

As shown in FIG. 1, during operation of the circuit 100 in a pre-charge mode, the switch of the pre-charged circuit is closed and the switch of the charging circuit is opened. Thus, current flow between the power source and load is limited to flow through the pre-charge circuit. During operation of the circuit 100 in a charging mode, such as shown in FIG. 2, the switch of the pre-charge circuit is opened and the switch of the charging circuit is closed. As such, current flow between the power source and load is limited to flow through the charging circuit.

As illustrated in FIG. 1, the pre-charge circuit further includes a resistive element 108 (e.g. a fixed-value or variable-value resistor) is arranged in series with the switch. During operation of the circuit 100 in the pre-charge mode, the resistor 108 forms a part of the current flow path that electrically connects the source and load, thereby increasing the equivalent series resistance (ESR) of the current path connecting the source and load. Given the inverse relationship between current flow and resistance, the increased ESR provided by the resistor of the pre-charge circuit acts to decrease current flow between the source and load. By limiting current flow through the circuit, the resistor of the pre-charge circuit thus, advantageously, helps minimize (e.g., prevent) over-current conditions within the circuit 100.

A switch 106 (e.g. a contactor) allows the resistor 108 to be selectively removed from the path of current flow to the load. The resistor 108 limits current flow from a source 102 to a load 104, according to one embodiment. When the capacitive elements of load 104 are sufficiently charged, switch 106 is set to the second position, as shown in FIG. 2, removing resistor 108 from the path of current flow to load 104, and thus initiating a second phase in the charging of the capacitive elements of the load 104 (i.e. a charging mode of operation). In some embodiments, switch 106 may be set to the second position when the capacitive elements of load 104 are charged to the same potential (i.e., voltage) as source 102, or when the capacitive elements of load 104 are charged to within a predetermined range (e.g., 90-95%) of the potential of source 102. During the charging mode of operation, energy is supplied to load 104 without being limited by resistor 108.

Although the resistor 108 acts to limit current flow to the capacitive load during the initial pre-charge mode of operation, thereby advantageously allowing capacitive elements of the load to charge in a controlled manner, the circuit 100 may nevertheless be subject to an initial, instantaneous surge of current immediately following the powering on of the load. The sudden, rapid increase in current flow responsive to a mechanical switch (e.g., contactor) of the electrical system being transitioned from closed to open and/or open to closed may cause arcing of the switch. As discussed above, the welding of a switch may prevent the circuit from being safely de-energized, and thus may pose a danger to a user.

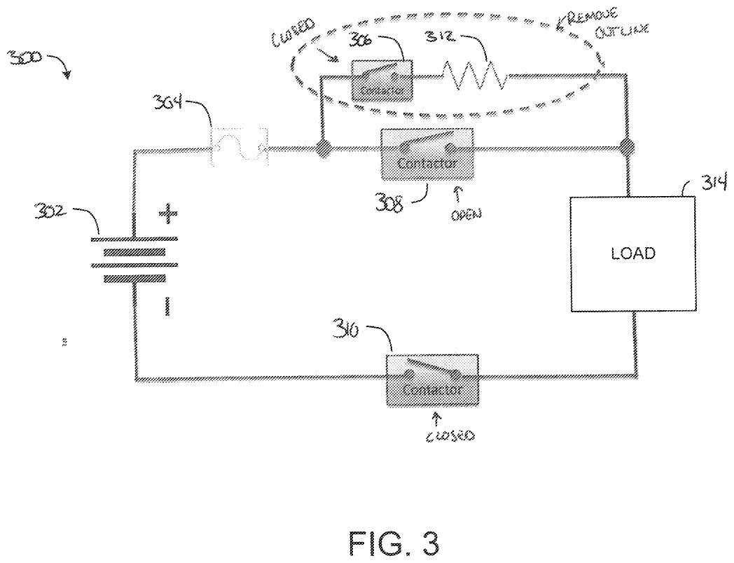

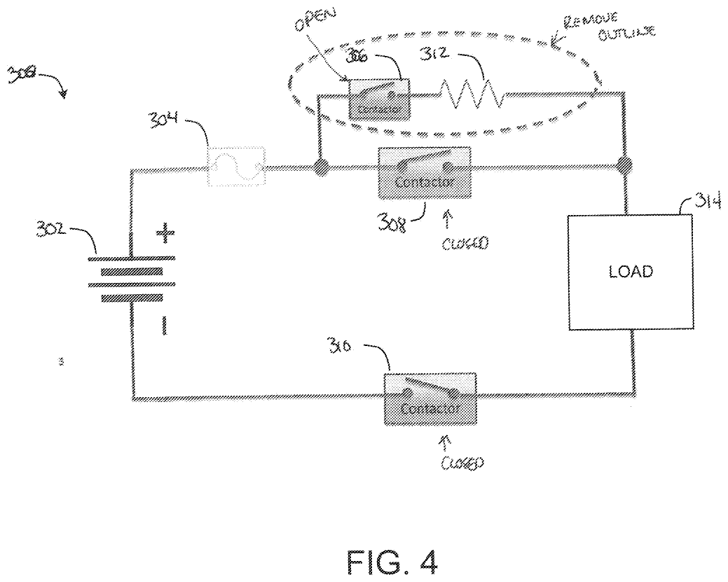

Accordingly, as illustrated by a pre-charge circuit 300 with redundancy shown in FIGS. 3 and 4, it may be desirable to provide the electrical system with one or more switches (e.g. contactors) to mitigate the dangers posed by welding, and thus to increase the reliability of the circuit 100. Circuit 300 is also shown to include a number of contactors (i.e., switches), including pre-charge contactor 306, main contactors 308, and redundancy contactor 310. Each of the contactors may be configured to control current flow to capacitive load 314, from source 302. In some embodiments, the contacts or conductors of each of pre-charge contactor 306, main contactor 308, and redundancy contactor 310 may be open at an initial state (e.g., normally open). One such solution is redundancy in the switches (i.e., contactors, relays, etc.) used to selectively configure the circuit between a pre-charge mode and an operating mode. For example, a secondary or tertiary switch (i.e., a redundancy switch) may be included on a negative or neutral branch of the circuit. The redundancy switch may be configured to open in the event that a main switch fails as a short circuit (e.g., due to welded contacts). In this manner, the redundancy switch is a secondary or back-up method for de-energizing the circuit (e.g., so that the circuit may be safely repaired). An optional fuse 304 may be arranged in series with each of the pre-charge branch and charging branch (as well as the source), allowing the power source 302 to be removed or disconnected from the circuit 300 in the event of an over-current condition.

In a pre-charge configuration, as shown in FIG. 3, pre-charge contactor 306 and redundancy contactor 310 are closed, and main contactor 308 remains open. This pre-charge configuration thereby allows current to flow from source 302 to load 314 through a current-limiting resistor 312. In this manner, the pre-charge configuration of FIG. 3 allows the capacitive components of load 314 to charge in a controlled manner. More specifically, current-limiting resistor provides a much greater resistance than the ESR of load 314, as described in detail above. In this manner, the flow of current to load 314 is controlled, substantially preventing or limiting surges in current when the capacitive elements of the load are being charged.

In an operating configuration, as shown in FIG. 4, pre-charge contactor 306 is opened and the main contactor 308 is closed, allowing current to flow from the source 302 to capacitive load 314 without being limited by resistor 312. In some embodiments, redundancy contactor 310 may open with pre-charge contactor 306 and subsequently close with main contactor 308. The circuit 300 may transition to the operating configuration shown in FIG. 4 responsive to the capacitive elements of load 314 reaching a pre-defined threshold, or at the end of a defined pre-charge cycle. For example, circuit 300 may transition to the operating configuration when the capacitive elements of load 314 reach at least a portion of the potential of the source (e.g., 80-90% of the source potential).

When transitioning to and/or from the pre-charge configuration and/or the operational configuration, at least one of pre-charge contactor 306 or main contactor 308 may still be susceptible to welded contacts due to arcing, as described above with respect to FIGS. 1 and 2. In event that the contacts of pre-charge contactor 306 and/or main contactor 308 weld together (i.e., short), redundancy contactor 310 may be opened, thereby de-energizing circuit 300. For at least this reason, redundancy contactor 310 increases the safety of circuit 300 when compared to circuit 100, for example.

While the addition of redundancy contactor (e.g., redundancy contactor 310) or switch may provide a secondary means for de-energize a circuit (e.g., circuit 300), each of the contactors (e.g., pre-charge contactor 306, main contactors 308, and redundancy contactor 310) may still be prone to the potential issues described above with respect to switch 106. For example, the contactors are mechanical switches with a limited lifespan, and may be prone to wear, arcing, latency, etc. Additionally, each additional contactor included in the pre-charge circuit may increase the number of potential points of failure. In some embodiments, the addition of a redundancy contactor also increases the packaging size and cost of circuit (e.g., when compared to a circuit such as circuit 100). In this regard, it may be desirable to provide a circuit for pre-charging a capacitive load (e.g., an inverter) that includes arc suppression and can be provided in a small, cost effective package.

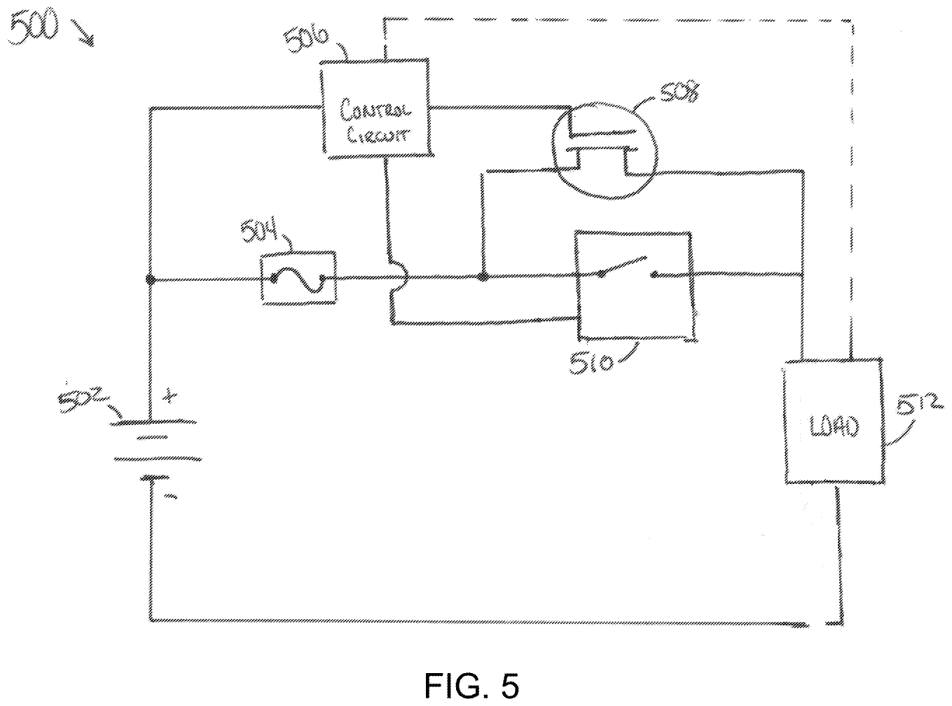

Referring now to FIG. 5, a diagram of an arc suppression pre-charge circuit 500 is shown, according to one embodiment. In addition to limiting current flow during an initial charging of a capacitive load, the pre-charge branch of the circuit 500 additionally eliminates the risk of electric arcing within the pre-charge branch. By providing such arc suppression, the pre-charged circuit is thus able to protect the circuit 500 against the risk of welding, without requiring the use of a redundancy contactor (such as, e.g., described with reference to the circuit 300 of FIGS. 3 and 4).

As shown in FIG. 5, circuit 500 includes a source 502 for providing energy to a load 512. The source 502 may be any AC or DC source (e.g., a battery, a generator, a grid, etc.) configured to provide energy to load 512. For example, in an EV or HEV, the source 502 may be a 48V Li-ion battery bank or a 12V lead acid battery. An optional fuse 504 is provided in series with source 502. The fuse 504 may operate to remove or disconnect source 502 from circuit 500 in the event of an over-current condition, thereby protecting the components of circuit 500. In some embodiments, the fuse 504 may be a contactor, breaker, relay, or any other functionally equivalent component. In some embodiments, circuit 500 is a pre-charge circuit included in a vehicle (e.g., an EV, a HEV, etc.) for pre-charging an inverter or another capacitive load of the vehicle. In other embodiments, circuit 500 is a pre-charge circuit for another capacitive load, such as in power converters, consumer electronics, motor drives, etc.

The circuit 500 further includes a main contactor 510 that may be selectively closed to provide energy from the source 502 to the capacitive load 512. The main contactor 510 may comprise a contactor, breaker, relay, or any other functionally equivalent component configured to selectively allow current flow to load 512. In some embodiments, the contacts or conductors of main contactor 510 may be open in an initial state (e.g., normally open). When closed, main contactor 510 may provide an alternate current path from source 502 to load 512, thereby bypassing a pre-charge branch of circuit 500.

The pre-charge branch of circuit 500 is shown to include a control circuit 506 and a voltage-controlled resistor 508. As described below, control circuit 506 may control the resistance of voltage-controlled resistor 508 and/or turn the voltage-controlled resistor 508 on and off (e.g., so that current flows or does not flow through voltage-controlled resistor 508). Control circuit 506 may be any circuit or electronic device configured to control voltage-controlled resistor 508. For example, control circuit 506 may include a microcontroller, an integrated circuit (IC), a relay, resistors (e.g., a voltage divider), a secondary source, or any other circuit or combination of components configured to control voltage-controlled resistor 508. In some embodiments, control circuit 506 may include one or more components configured to identify a charge level of the capacitive elements of load 512.

Voltage-controlled resistor 508 may be any electronic component where an input voltage controls a resistance of the component. In some embodiments, voltage-controlled resistor 508 acts as a switch, where turning voltage-controlled resistor 508 on (e.g., when control circuit 506 applies a sufficient voltage) allows current to flow through the device. In some such embodiments, the resistance value of voltage-controlled resistor 508 is variable based on an input voltage to the device. In some embodiments, voltage-controlled resistor 508 is turned off (e.g., current is restricted from flowing through the device) when the applied voltage is below a threshold, or when a voltage is not applied.

In some embodiments, voltage-controlled resistor 508 is a field-effect transistor (FET). Voltage-controlled resistor 508 may be a junction field-effect transistor (JFET), metal-oxide-semiconductor field-effect transistor (MOSFET), or other type of FET that is operable as a voltage-controlled resistor, for example. In general, certain FETs are known to operate in a linear region (i.e., ohmic region, triode region), where the FET operates as a resistor, and the resistance value of the FET is determined by the gate-source voltage of the device. By utilizing the FET and operating in linear mode with higher resistance, the parallel contactor and large resister can be removed, thus combining the operation of the charge pump and arc suppression. Additionally, FETs are known to operate in a cut-off region and/or an active region, where the FET allows current flow or restricts current flow in such regions, respectively.

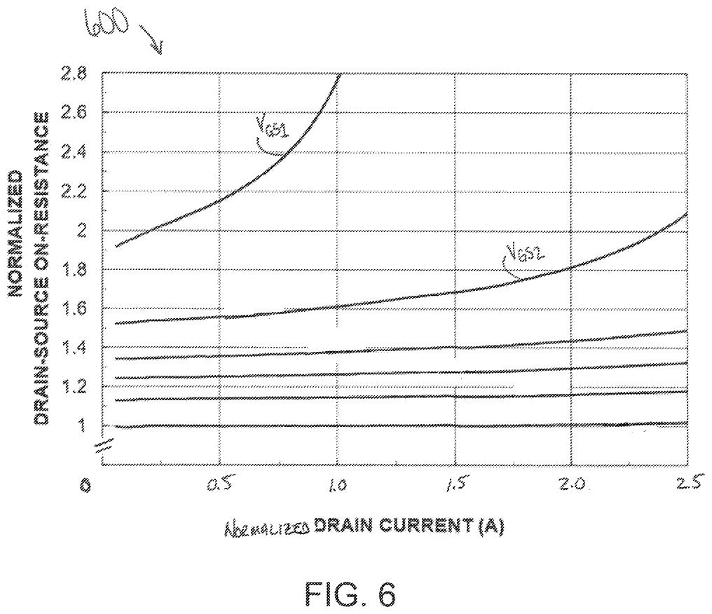

Referring now to FIG. 6, an example graph 600 illustrating the resistance value of a MOSFET varying with an applied gate-source voltage is shown, according to some embodiments. More specifically, graph 600 may illustrate the drain-source resistance of a MOSFET when operating in a linear region or linear mode. In general, a MOSFET operates in the linear mode when the gate-source voltage of the MOSFET is greater than a threshold value (e.g., the MOSFET is turned on) and the drain-source voltage is less than the difference between the gate-source voltage and the threshold voltage. In the linear mode, the MOSFET operates as a resistor, where the equivalent resistance value of the MOSFET is variable based on the applied gate-source voltage.

As shown in graph 600, the normalized drain-source resistance (e.g., the normalized equivalent resistance) may decrease as the gate-source voltage is increased. Generally, the relationship between an applied gate-source voltage and the equivalent resistance of the MOSFET is known (i.e., predetermined) based on manufacturer specifications, construction, or other attributes of the MOSFET. As shown in graph 600, for example, line V_{GS1} may represent the equivalent resistance of the MOSFET at a first gate-source voltage and line V_{GS2} may represent the equivalent resistance of the MOSFET at a second gate-source voltage, where V_{GS1}<V_{GS2}. In this manner, graph 600 illustrates how a MOSFET operates as a voltage-controlled resistor based on applied gate-source voltage.

Advantageously, a pre-charge circuit including a voltage-controlled resistor, such as a MOSFET, may provide a number of advantages over other pre-charge circuits and/or cure a number of deficiencies, as described above. For example, a MOSFET is generally significantly smaller in packaging size over the contactors and resistors utilized by other pre-charge circuits, such as circuit 300. More specifically, a MOSFET may function as both a switch and a resistor, eliminating the need for two separate components. Generally, MOSFETS and/or other similar solid-state, voltage controlled resistors are more reliable that mechanical switches that are prone to wear and failure, as solid-state components contain few, if any moving parts. Additionally, MOSFETs and other similar solid-state, voltage controlled resistors are not susceptible to contact welding due to arcing, increasing safety and reliability and eliminating the need for a redundancy contactor. For at least these reason, replacing pre-charge contactor 306 and resistor 312 of circuit 300 with voltage-controlled resistor 508 may provide a pre-charge circuit with arc suppression in a smaller, more cost effective package.

Referring again to FIG. 5, in a pre-charge configuration, main contactor 510 remains open and a voltage is applied to voltage-controlled resistor 508 by control circuit 506. As described above with respect to FIG. 6, the applied voltage is generally configured to bias voltage-controlled resistor 508 into a linear mode. In this regard, the applied voltage is generally greater than a lower threshold voltage required to turn on voltage-controlled resistor 508 (e.g., to allow current flow). As described above, the applied voltage for the pre-charge configuration may be pre-determined or known based on one or more parameters of voltage-controlled resistor 508.

In some embodiments, the applied voltage is variable, thereby varying the equivalent resistance value of voltage-controlled resistor 508. Advantageously, this may provide greater control over the rate at which the capacitive components of load 512 charge. For example, when the capacitive elements of load 512 are severely depleted (i.e., not charged), the resistance value of voltage-controlled resistor 508 may be much greater than when the capacitive elements of load 512 are close to full charged. This may provide safer and faster charging over traditional, fixed-value resistors.

Once the capacitive components of load 512 are sufficiently charged, circuit 500 may switch to an operating configuration. In some embodiments, circuit 500 may be configured to the operating configuration responsive to the capacitive elements of load 512 reaching a pre-defined threshold (e.g., as determined by control circuit 506), or at the end of a defined pre-charge cycle. For example, circuit 500 may be configured to the operating configuration when the capacitive elements of load 512 reach at least a portion of the potential of source 502 (e.g., of the source potential). In the operating configuration, main contactor 510 may close and control circuit 506 may configure voltage-controlled resistor 508 to an off state (i.e., voltage-controlled resistor 508 is biased to a cut-off region or mode), thereby allowing current to flow to load 512 without being limited by voltage-controlled resistor 508.

In some embodiments, at least a portion of circuit 500 may be included in an arc suppression pre-charge device. In some embodiments, the arc-suppression pre-charge device may further include a housing containing at least a portion of circuit 500. For example, at least control circuit 506, voltage-controlled resistor 508, and contactor 510 may be included in a single housing. In some embodiments, the arc suppression pre-charge device may be included in a standard housing or device, such as a standard four or five pin automotive relay. In some such embodiments, the included portions of circuit 500 and/or may be placed between a source (e.g., a battery) and a load (e.g., an inverter). In other embodiments, at least a portion of circuit 500 may be included in another device or circuit. For example, at least control circuit 506, voltage-controlled resistor 508, and contactor 510 may be included in an inverter, converter, or another similar device. In other examples, at least control circuit 506, voltage-controlled resistor 508, and contactor 510 may be included in a bussed electrical center (BEC), a battery controller, a battery management system (BMS), etc. Utilizing an arc suppression bypass FET for pre-charging eliminates the need for an additional resistor when the FET operates in linear mode to function as its own resistance, thus extending contactor life with arc suppression.

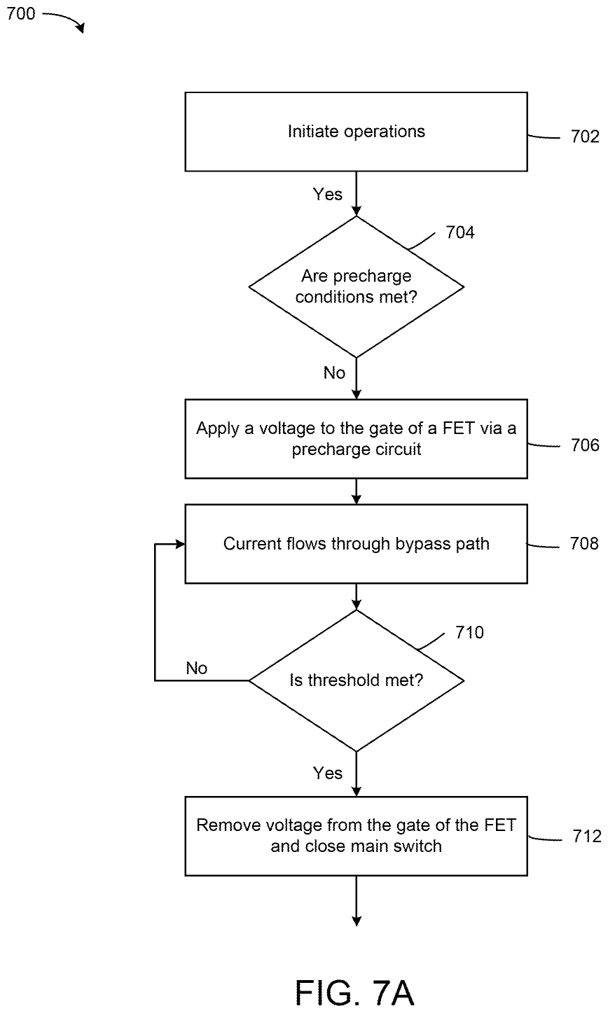

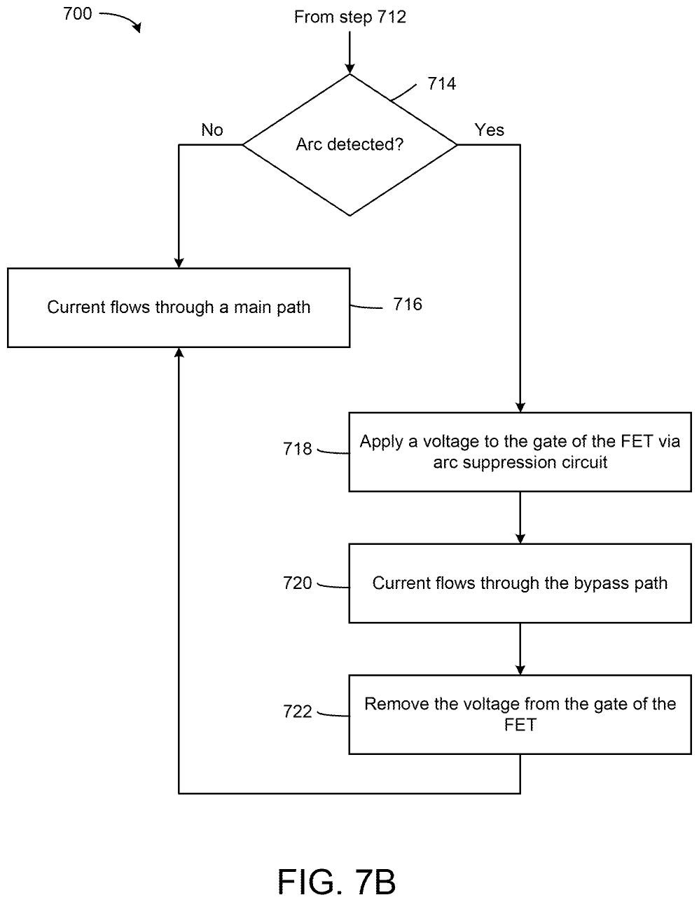

Referring now to FIGS. 7A-7B, a method of using an arc suppression pre-charge circuit is shown, according to the example embodiment described in FIG. 5. At step 702, the control circuit 506 initiates operations of the arc suppression pre-charge circuit. At step 704, the control circuit 506 identifies whether pre-charge conditions are met. If the pre-charge conditions are not met, the control circuit 506 moves to step 706, wherein the control circuit 506 applies a voltage to the gate of an FET via the pre-charge circuit. As such, at step 708, the current flow through the bypass path. As described herein, control circuit 506 may control the resistance of voltage-controlled resistor 508 (e.g., FET) and/or turn the voltage-controlled resistor 508 on and off (e.g., so that current flows or does not flow through voltage-controlled resistor 508). In some embodiments, voltage-controlled resistor 508 acts as a switch, where turning voltage-controlled resistor 508 on (e.g., when control circuit 506 applies a sufficient voltage) allows current to flow through the device. In some such embodiments, the resistance value of voltage-controlled resistor 508 is variable based on an input voltage to the device. In some embodiments, voltage-controlled resistor 508 is turned off (e.g., current is restricted from flowing through the device) when the applied voltage is below a threshold, or when a voltage is not applied. At step 710, control circuit 506 determines whether a charge threshold is met. If the charge threshold is not met, the control circuit 506 repeats step 708. If the charge threshold is met, voltage is removed from the gate of the FET and the main switch or contactor 510 is closed at step 712. At step 714, the control circuit 506 detects an arc. If an arc is not detected, current flows through the main path at step 716. If an arc is detected, voltage is applied to the gate of the FET via arc suppression circuit. Then, at step 720, current flows through the bypass path. At step 722, the voltage is removed from the gate of the FET and current flows through the main path (returning back to step 716.

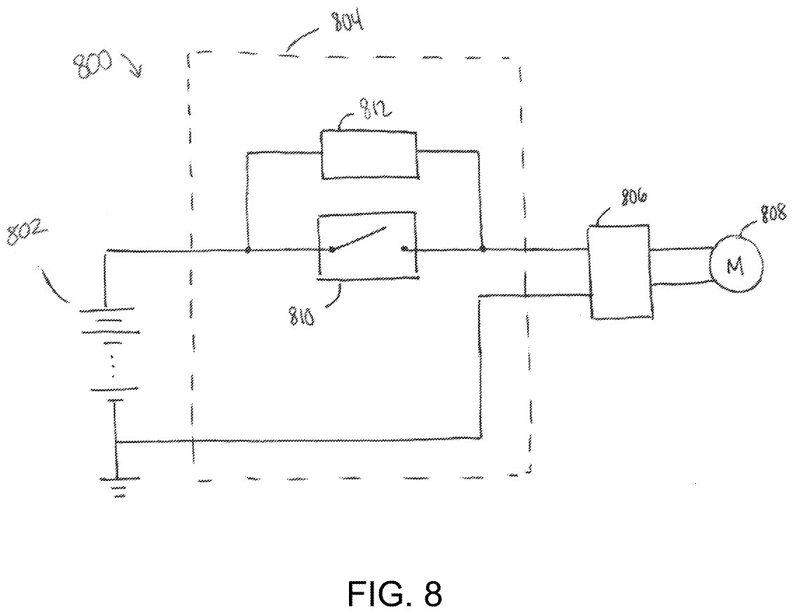

As shown in FIG. 8, at least the pre-charge components of circuit 800 may be included in a drive system for a motor 808, according to some embodiments. Energy may be fed from a battery pack 802, through a battery pack controller 804 and an inverter 806, to motor 808. In some embodiments, battery pack 802 is mounted on a vehicle, such as an EV or HEV, and motor 808 is a main drive motor for the vehicle. Battery pack controller 804 is shown to include a main contactor 810 that may selectively allow or prevent current flow from battery pack 802. In some embodiments, contactor 810 may be any type of contactor, switch, or relay, similar to contactor 510, configured to turn on or turn off the power to inverter 806, and subsequently motor 808.

Battery pack controller 804 is shown to further include a pre-charge circuit 812, in parallel with main contactor 810. In some embodiments, pre-charge circuit 812 may include a voltage-controlled resistor and a control circuit for controlling the voltage-controlled resistor. For example, pre-charge circuit 812 may include control circuit 506 and voltage-controlled resistor 508, as described with reference to FIG. 5. As described above, pre-charge circuit 812 may provide an initial charging current to inverter 806, to charge one or more capacitive elements of inverter 806. After charging has been completed, main contactor 810 may close, providing operating current to inverter 806 and motor 808. In various embodiments, battery pack controller 804 is configured to be attached to battery pack 802, or may be a separate device placed between battery pack 802 and inventor 806. For example, battery pack controller 804 may take the form of a typical four or five-pin mini relay for automotive use, as described in detail below.

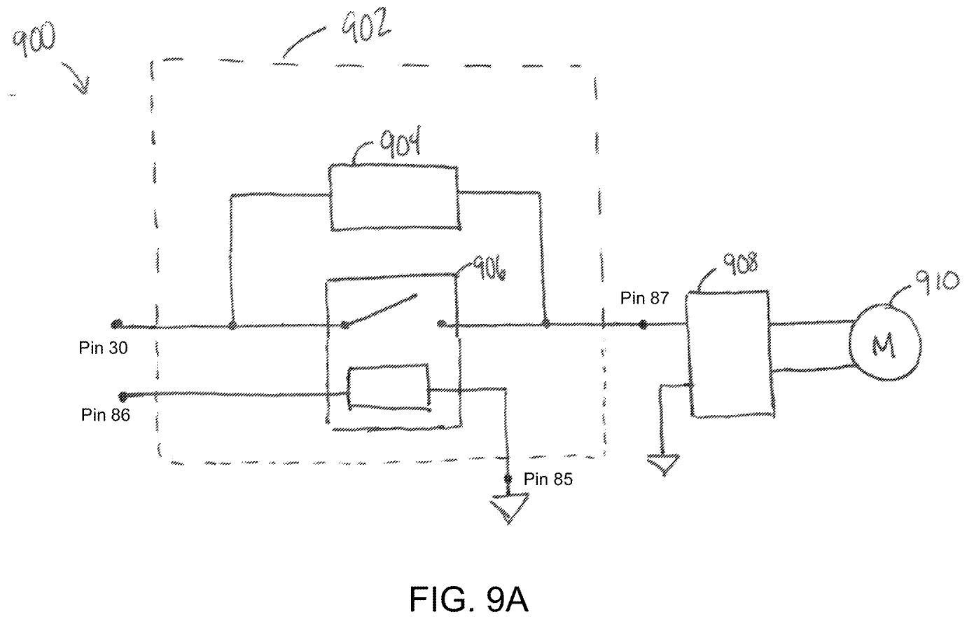

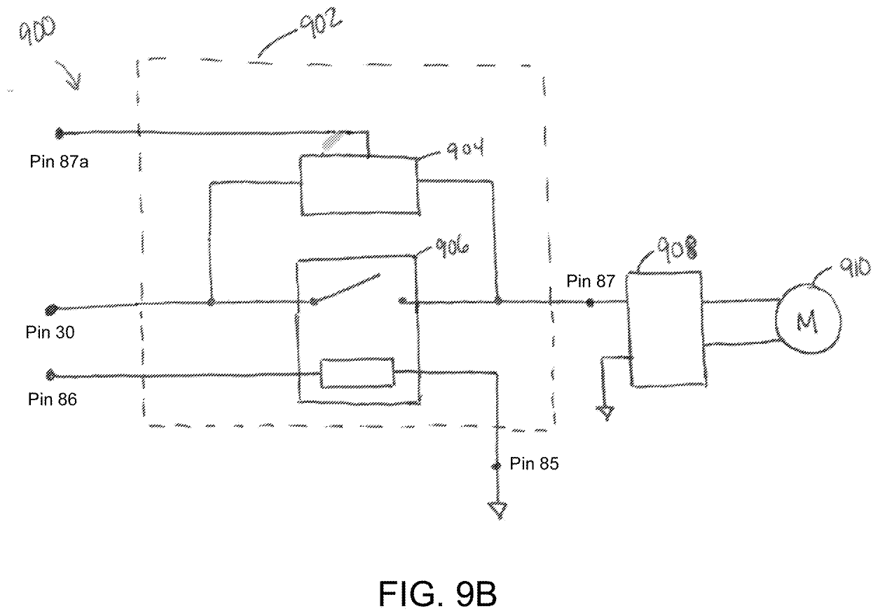

Referring now to FIGS. 9A-9B, a pre-charge circuit 900 housed within a four-pin mini relay is shown in FIG. 9A, according to one embodiment, and a pre-charge circuit 900 housed within a five-pin mini relay is shown in FIG. 9B, according to another embodiment. The four-pin or five-pin mini relay (e.g., pins 85, 86, 87, 87a and 30) may be an ISO mini relay typically used in the automotive industry, for example. In this manner, the four or five-pin mini relay may be easily integrated into current or future automotive applications. For example, a four-pin mini relay that includes a pre-charge circuit may be retrofitted to a current automobile, or may be incorporated into a future design. Advantageously, by utilizing a standard form such as a four or five-pin ISO mini relay, a pre-charge circuit may be incorporated into a system using standard connectors or components.

As shown, the mini relay has a housing 902 that encloses various components of the device. For example, housing 902 is shown to contain a pre-charge circuit 904 and a main contactor 906. Main contactor 906 may be selectively closed via contactor 906 to provide energy from a source to a capacitive load, or an inverter 908 to a motor 910, as illustrated via pin 87. The main contactor 906 may comprise a contactor, breaker, relay, or any other functionally equivalent component configured to selectively allow current flow to load. It will be appreciated that housing 902 may contain more or fewer components for various applications. In some embodiments, control circuit 902 and/or a voltage controlled resistor may receive power via pin 30. In a five-pin relay, power may be received via pin 86 or 87a. In such embodiments, power may be received from any number of sources, such as a battery. Pin 85, for instance, may be grounded.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. For example, the optional fuse of the exemplary embodiment described in at least paragraph(s) may be incorporated in the circuit of the exemplary embodiment described in at least paragraph(s) [0043]. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An arc suppression pre-charge circuit comprising:
a source for providing energy to a load;
a main contactor selectively closed to provide energy from the source to the load, wherein the main contactor provides an alternate current path from the source to the load and bypasses a pre-charge branch of the circuit when the main contactor is closed; and
the pre-charge branch, comprising:
a voltage-controlled resistor; and
a control circuit configured to control a resistance of the voltage-controlled resistor.

2. The arc suppression pre-charge circuit of claim 1, wherein the power source is at least one of an alternating current (AC) source, a direct current (DC) source, a battery, a generator, or a grid.

3. The arc suppression pre-charge circuit of claim 1, wherein the load is at least one of a converter configured to convert alternating current (AC) to direct current (DC) or an inverter configured to convert DC to AC.

4. The arc suppression pre-charge circuit of claim 1, wherein the main contactor is a mechanical, multi-pole switch configured to selectively transition between an open configuration and a closed configuration.

5. The arc suppression pre-charge circuit of claim 4, wherein, in the open configuration, current is blocked from flowing across the main contactor, and wherein, in the closed configuration, current flows across the main contactor.

6. The arc suppression pre-charge circuit of claim 1, wherein the control circuit is configured to control the resistance of the voltage-controlled resistor, to cause current to flow through the main contactor to the load instead of through the voltage-controlled resistor.

7. The arc suppression pre-charge circuit of claim 6, wherein, in response to capacitive elements of the load being charged, the control circuit is configured to control the resistance to cause the current to flow through the main contactor to the load instead of through the voltage-controlled resistor.

8. The arc suppression pre-charge circuit of claim 1, further comprising a charging branch in parallel with the pre-charge branch, between the source and the load.

9. The arc suppression pre-charge circuit of claim 8, wherein the charging branch comprises a switch for selectively establishing a current flow path between the power source and load.

10. The arc suppression pre-charge circuit of claim 1, further comprising a redundancy switch between the power source and the load, the redundancy switch configured to open in response to a detected failure of the main contactor.

11. The arc suppression pre-charge circuit of claim 1, further comprising a fuse arranged in series with the pre-charge branch, the fuse configuring to de-couple the power source from the circuit in response to an over-current condition.

12. The arc suppression pre-charge circuit of claim 11, wherein the fuse is at least one of a contactor, a breaker, or a relay.

13. An arc suppression pre-charge device comprising:
a housing;
an arc suppression pre-charge circuit at least partially disposed in the housing, the arc suppression pre-charge circuit comprising:
a source for providing energy to a load;
a main contactor selectively closed to provide energy from the source to the load, wherein the main contactor provides an alternate current path from the source to the load and bypasses a pre-charge branch of the circuit when the main contactor is closed; and
the pre-charge branch of the circuit, comprising:
a voltage-controlled resistor; and
a control circuit configured to control a resistance of the voltage-controlled resistor.

14. The arc suppression pre-charge device of claim 13, wherein the housing is a single housing configured to house at least the control circuit, the voltage-controlled resistor, and the main contactor.

15. The arc suppression pre-charge device of claim 13, wherein the housing is at least one of a four pin relay or a five pin relay.

16. The arc suppression pre-charge device of claim 15, wherein at least one of the control circuit or the voltage controlled resistor is configured to receive power via a pin of the four pin relay or the five pin relay.

17. The arc suppression pre-charge device of claim 13, wherein the control circuit is configured to control the resistance of the voltage-controlled resistor, to cause current to flow through the main contactor to the load instead of through the voltage-controlled resistor.

18. The arc suppression pre-charge device of claim 17, wherein, in response to capacitive elements of the load being charged, the control circuit is configured to control the resistance to cause the current to flow through the main contactor to the load instead of through the voltage-controlled resistor.

19. A method of using an arc suppression pre-charge circuit, the method comprising:
initiating operations of the arc suppression pre-charge circuit;
in response to determining that pre-charge conditions of a load are not met, applying a voltage to a gate of a voltage-controlled resistor via the arc suppression pre-charge circuit, the voltage applied to the gate causing current to flow through a pre-charge branch of the pre-charge circuit along a bypass path to the load, instead of through a main contactor to the load.

20. The method of using an arc suppression pre-charge circuit of claim 17, further comprising:
determining a charge threshold is met;
in response to the charge threshold being met, removing the voltage from the gate of the voltage-controlled resistor to cause current to flow through the main contactor to the load;
detecting, following current flowing through the main contactor to the load, an arc;
in response to detecting the arc, re-applying the voltage to the gate of the voltage-controlled resistor via the arc suppression pre-charge circuit to cause current to flow through the pre-charge branch along the bypass path to the load.
